(19) United States
(12) Patent Application Publication
(10) Pub. No.: US 2022/0398269 A1
(43) Pub. Date: Dec. 15, 2022

(54) COMMUNICATION MANAGEMENT METHOD AND INFORMATION PROCESSING APPARATUS

(71) Applicant: FUJITSU LIMITED, Kawasaki-shi (JP)

(72) Inventors: Yuki Shigyo, Ota (JP); Kazuki Akita, Yokohama (JP); Tetsuya Okano, Setagaya (JP); Toshihiro Mino, Hiratsuka (JP); Naomi Isomura, Suginami (JP)

(73) Assignee: FUJITSU LIMITED, Kawasaki-shi (JP)

(21) Appl. No.: 17/716,228

(22) Filed: Apr. 8, 2022

(30) Foreign Application Priority Data
Jun. 15, 2021 (JP) 2021-099246

(51) Int. Cl. G06F 16/28; G06F 16/901; G06F 16/2455; G06K 9/62

(52) U.S. Cl. CPC G06F 16/288; G06F 16/9024; G06F 16/2456; G06K 9/6215

(57) ABSTRACT

A non-transitory computer-readable recording medium stores a program that causes a computer to execute a process, the process includes obtaining first graph information indicating a relationship between elements of a plurality of elements included in communication information on a first group, obtaining second graph information indicating a relationship between elements of a plurality of elements included in communication information on a second group, comparing the first graph information and the second graph information, and outputting information that recommends to merge the first group and the second group when it is determined that the first graph information and the second graph information are similar based on a result of the comparison.

### CROSS-REFERENCE TO RELATED APPLICATION

This application is based upon and claims the benefit of priority of the prior Japanese Patent Application No. 2021-99246, filed on Jun. 15, 2021, the entire contents of which are incorporated herein by reference.

### FIELD

The embodiment discussed herein is related to a communication management method and an information processing apparatus.

### BACKGROUND

In the past, as a method that enables simultaneous conversations about two or more subjects in one online meeting, there is a function that groups participants therein so that the participants may talk in each of the groups. There is a case where, after participants are once grouped and conversations are started, a plurality of groups are preferably merged to talk together in accordance with some details of the conversations within the groups.

As a technology in the past, there is a technology for grouping participants in advance so that the participants may enter statements or exchange information through online communication in each of the groups and for generating a new group, merging groups, dividing a group, and exchanging members. There is another technology that determines a discussion state of a group based on behaviors in a virtual meeting room of participants belonging to the group and a discussion determination criterion, identifies and categorizes the participants based on the behaviors of the participants and a participant determination criterion, and re-divides the participants into groups based on a discussion state determination result, a categorization result, and a group reorganization reference. There is another technology that, when a merge request is input from a terminal with merge/separation request authority in a state that a plurality of group communications is being held, voices of the plurality of group communications are switched to a large conference trunk and are coupled so that a merged group communication may be held.

International Publication Pamphlet No. WO2008/078555, International Publication Pamphlet No. WO2016/117070, and Japanese Laid open Patent Publication No. 2011-91582 are disclosed as related art.

### SUMMARY

According to an aspect of the embodiment, a non-transitory computer-readable recording medium stores a program that causes a computer to execute a process, the process includes obtaining first graph information indicating a relationship between elements of a plurality of elements included in communication information on a first group, obtaining second graph information indicating a relationship between elements of a plurality of elements included in communication information on a second group, comparing the first graph information and the second graph information, and outputting information that recommends to merge the first group and the second group when it is determined that the first graph information and the second graph information are similar based on a result of the comparison.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an embodiment of a communication management method;

FIG. 2 is a diagram illustrating a system configuration example of an information processing system;

FIG. 3 is a diagram illustrating a hardware configuration example of a communication management apparatus;

FIG. 4 is a diagram illustrating a hardware configuration example of a client apparatus;

FIG. 5 is a diagram illustrating a specific example of a key graph;

FIG. 6 is a diagram illustrating an example of stored data in an evaluation word DB;

FIG. 7 is a diagram illustrating a functional configuration example of the communication management apparatus;

FIG. 8A is a diagram (Part 1) illustrating an example of generation of a key graph;

FIG. 8B is a diagram (Part 2) illustrating an example of generation of a key graph;

FIG. 9 is a diagram illustrating an example of extraction of a partial key graph;

FIG. 10 is a diagram illustrating a screen example of a merge recommendation screen;

FIG. 11 is a diagram (Part 1) illustrating an example of an operation of the information processing system;

FIG. 12 is a diagram (Part 2) illustrating an example of an operation of the information processing system;

FIG. 13 is a diagram (Part 3) illustrating an example of an operation of the information processing system;

FIG. 14 is a diagram (Part 4) illustrating an example of an operation of the information processing system;

FIG. 15 is a diagram illustrating an example of update of stored data in an evaluation word DB;

FIG. 16 is a flowchart illustrating an example of processing for merge recommendation in the communication management apparatus; and

FIG. 17 is a flowchart illustrating an example of processing for merge evaluation in the communication management apparatus.

### DESCRIPTION OF EMBODIMENT

According to the technologies in the past, it is difficult to recommend to merge groups having similar details of conversations (communications).

Hereinafter, an embodiment will be described in detail with reference to the drawings.

### Embodiment

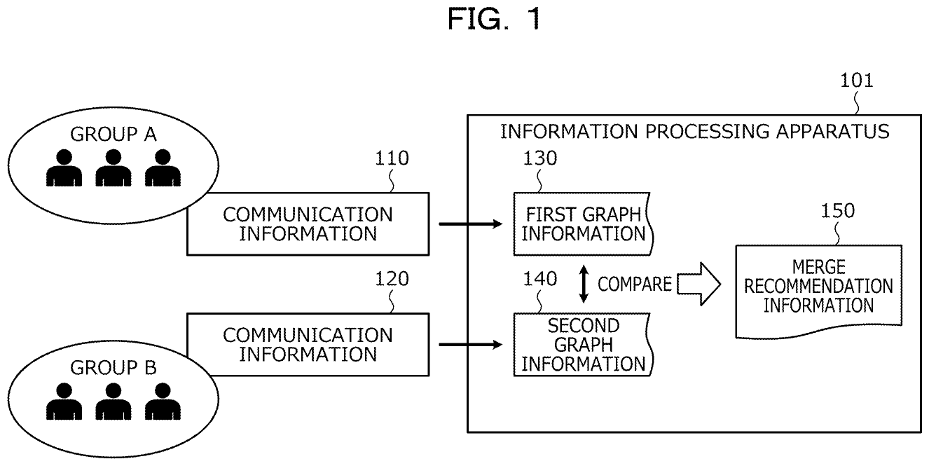

FIG. 1 is a diagram illustrating an embodiment of a communication management method. Referring to FIG. 1, an information processing apparatus 101 is a computer that outputs information that recommends to merge groups. The term “group” refers to a collection of users who perform online communication.

The term “online communication” refers to a communication in which mutual interactions are performed over a network such as the Internet or the like. The online communication may be, for example, voice-based communication or text-based communication. The term “merge” refers to integrating a plurality of groups into one group.

For example, a group is formed when two or more subjects are talked simultaneously in one online meeting. The online meeting is used for, for example, get-together which is held in school, in business or the like. For example, a group may be formed by a breakout room set for grouping participants. The breakout room is a function of an online communication tool and is a function for grouping participants so that the participants may talk in groups.

In some cases, participants in one group may be talking about a similar subject to the subject being talked in another group. In this case, if the participants in the different groups are allowed to talk together, they may advantageously dig deeper into the subject, augmenting the scene or achieving more meaningful discussion.

As an existing technology relating to online communication, there is a technology in which mutual voices may be heard when corresponding icons on a screen come closer while voices may not be heard when the icons come away. However, although, according to this existing technology, each of the participants may “listen for” subjects of other groups, it takes time and is not realistic to listen to conversations of all groups and determine that the same subject is being talked.

Possibly, each of participants may once leave a group to which he or she belongs and participate in another group to check details being talked in the group. However, in order for all of the participants within a group to move, each of the participants is to individually move. Participating in all groups to check details that are being talked in the groups leads to great time loss.

A method may be considered in which a host of an online meeting listens to details of talk in each group and merge two groups in which the same subject is being talked. However, the number of talks that a human being is able to hear simultaneously is limited. Therefore, as the number of groups increases, the number of talks to be listened by the host in parallel and simultaneously increases, which may no longer be handled.

In this way, it is difficult to manually check details that are being talked in each of groups and merge different groups. Therefore, for example, it may be considered that details of conversations in two groups are compared, and when the two groups are determined as groups in which the same subject is being talked if an identical word appears, the two groups are automatically merged.

However, in a case where only words are compared, it is difficult to merge the groups in consideration of contexts of the talks, which may possibly cause improper merge. The term “improper merge” refers to merging two groups independently of details of the subjects of the two groups.

For example, there may be a case where words “personnel affairs in a large company” appear in one group, and words “sales in a large company” appear in another group. In this case, although the common words “large company” are appearing, improper merge occurs when the word-based merging is performed on the groups in which one group is talking about personnel affairs while the other group is talking about sales.

Accordingly, a communication management method according to an embodiment will be described which performs context-based comparison on details of conversations of groups by using graph information indicating a relationship between elements of a plurality of elements included in communication information on each of the groups and recommends to merge the groups having similar details of the conversations. Hereinafter, a processing example of the information processing apparatus 101 will be described.

(1) The information processing apparatus 101 obtains first graph information indicating a relationship between elements of a plurality of elements included in communication information on a first group and second graph information indicating a relationship between elements of a plurality of elements included in communication information on a second group. The communication information is acquired by converting audio data acquired by recording data of a conversation of each group to text data.

An element included in the communication information is, for example, a word or a phrase. For example, a plurality of elements includes an element indicating a highly frequent word and an element indicating an insistence word. The term “highly frequent word” refers to a term (word) that frequently appears in communication information. The term “insistence word” refers to a term (word) described by the highly frequent word. The relationship between elements is, for example, a co-occurrence relationship. The co-occurrence is appearance of one element and another element at the same time. The range of the co-occurrence may be arbitrarily set and, for example, may be set for one sentence, audio data for a predetermined period of time, or the like.

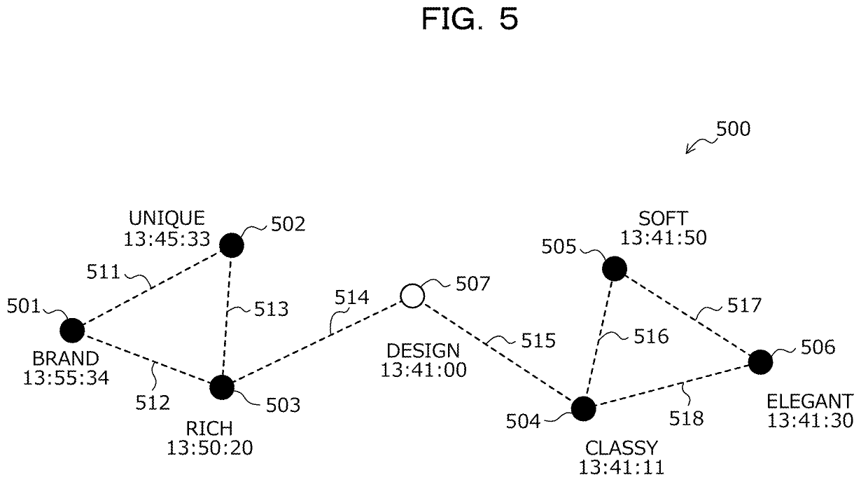

As the graph information, for example, a key graph may be used which includes an element (base) representing a highly frequent word and an element (roof) representing an insistence word and represents a relationship between elements having a co-occurrence relationship by a pillar (coupling). A specific example of the key graph will be described later with reference to FIG. 5.

The example in FIG. 1 assumes a case where first graph information 130 and second graph information 140 are obtained. The first graph information 130 indicates a relationship between elements of a plurality of elements included in communication information 110 on a group A. The communication information 110 is acquired by converting audio data acquired by recording data of a conversation of the group A to text data. The second graph information 140 indicates a relationship between elements of a plurality of elements included in communication information 120 on a group B. The communication information 120 is acquired by converting audio data acquired by recording data of a conversation of the group B to text data.

(2) When the information processing apparatus 101 determines that the first graph information and the second graph information are similar based on a result of a comparison between the first graph information and the second graph information, the information processing apparatus 101 outputs information that recommends to merge the first group and the second group. The information that recommends to merge is, for example, information that recommends to merge with another group for enabling communication involving the participants of the other group.

The output destination of the information that recommends to merge is, for example, a manager of each of the groups (first group and second group). For example, the manager may be any participant (member) within a group or may be a person other than the participants. The output destination of the information that recommends to merge may be all participants within a group, for example.

For example, the information processing apparatus 101 calculates a similarity between the first graph information and the second graph information based on a result of the comparison between the first graph information and the second graph information. When the calculated similarity is greater than or equal to a threshold value, the information processing apparatus 101 outputs the information that recommends to merge the first group and the second group. The threshold value may be arbitrarily set to a value which allows determination that the first graph information and the second graph information are similar when the similarity is greater than or equal to the threshold value.

A higher value of the similarity is calculated when, for example, a larger part is matched between the first graph information and the second graph information. By comparing between graph information pieces (first graph information and second graph information), the information processing apparatus 101 may determine the degree of similarity between details of conversations in consideration of, for example, not only words but also a relationship between words.

The example in FIG. 1 assumes a case where the first graph information 130 and the second graph information 140 are determined as being similar as a result of the comparison between the first graph information 130 and the second graph information 140. In this case, the information processing apparatus 101 outputs merge recommendation information 150 to the manager of each of the groups A and B, for example. The merge recommendation information 150 is information that recommends to merge the group A and the group B.

In this way, with the information processing apparatus 101, merging groups in which similar details are being talked in their conversations may be recommended by using graph information indicating a relationship between elements of a plurality of elements included in communication information on each of the groups (first group, second group). For example, the information processing apparatus 101 may perform context-based comparison on details of conversations between groups by comparing graph information pieces (first graph information, second graph information), instead of comparison on words only, and may thus determine whether the groups are to be merged or not.

In the example in FIG. 1, by comparing the first graph information 130 and the second graph information 140, similarity of details of conversations between the groups A and B is automatically determined so that merging of the groups A and B which are talking about the same subject may be recommended.

(System Configuration Example of Information Processing System 200)

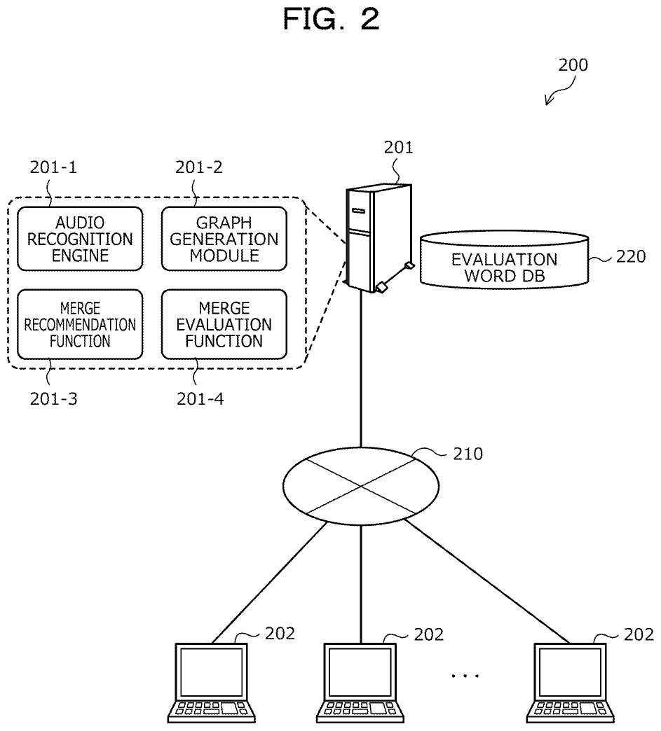

Next, with reference to FIG. 2, description will be given of a system configuration example of an information processing system 200 including the information processing apparatus 101 illustrated in FIG. 1. A case where the information processing apparatus 101 illustrated in FIG. 1 is applied to a communication management apparatus 201 within the information processing system 200 will be described hereinafter as an example. The information processing system 200 is applied to, for example, a service that manages online communication.

As an example, “online meeting” will be described as an online communication in the following description. Groups are formed by, for example, setting breakout rooms and grouping participants. For that, each of the groups formed by grouping participants of an online meeting is called a “breakout room” in some cases.

FIG. 2 is a diagram illustrating a system configuration example of the information processing system 200. Referring to FIG. 2, the information processing system 200 includes the communication management apparatus 201 and a plurality of client apparatuses 202. In the information processing system 200, the communication management apparatus 201 and the client apparatuses 202 are coupled to each other over a wired or wireless network 210. The network 210 is, for example, the Internet, a local area network (LAN), a wide area network (WAN), or the like.

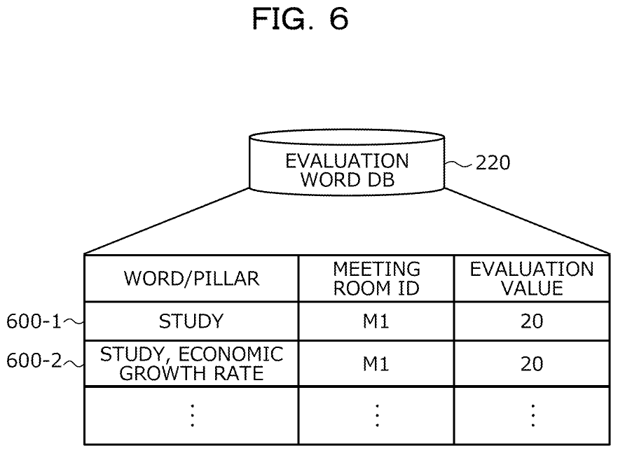

The communication management apparatus 201 has an evaluation word database (DB) 220 and outputs information that recommends to merge breakout rooms (groups). For example, the communication management apparatus 201 is a server. The data stored in the evaluation word DB 220 will be described later with reference to FIG. 6.

Each of the client apparatuses 202 is a computer to be used by a user. The user is, for example, a participant in an online meeting. The client apparatuses 202 are, for example, personal computers (PC), tablet PCs, smartphones, and so on.

In the information processing system 200, the communication management apparatus 201 includes, for example, an audio recognition engine 201-1, a graph generation module 201-2, a merge recommendation function 201-3, and a merge evaluation function 201-4. The audio recognition engine 201-1 is a program that converts audio data to text data.

The graph generation module 201-2 is a program that generates a key graph. For the audio recognition and key graph generation, an existing audio recognition technology and key graph generation technology may be used. The merge recommendation function 201-3 is a program that recommends to merge breakout rooms. The merge evaluation function 201-4 is a program that evaluates validity of the merge recommended by the merge recommendation function 201-3.

(Hardware Configuration Example of Communication Management Apparatus 201)

Next, a hardware configuration example of the communication management apparatus 201 will be described.

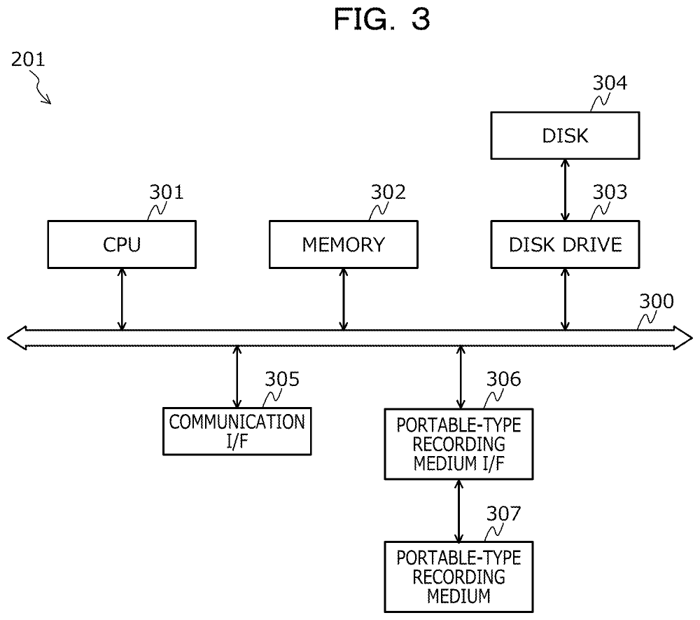

FIG. 3 is a diagram illustrating a hardware configuration example of the communication management apparatus 201. Referring to FIG. 3, the communication management apparatus 201 includes a central processing unit (CPU) 301, a memory 302, a disk drive 303, a disk 304, a communication interface (I/F) 305, a portable-type recording medium I/F 306, and a portable-type recording medium 307. These components are coupled to one another through a bus 300.

The CPU 301 controls the entirety of the communication management apparatus 201. The CPU 301 may include a plurality of cores. The memory 302 includes, for example, a read-only memory (ROM), a random-access memory (RAM), a flash ROM, and the like. For example, the flash ROM stores a program of an operating system (OS), the ROM stores application programs, and the RAM is used as a work area for the CPU 301. The programs stored in the memory 302 are loaded by the CPU 301, thereby causing the CPU 301 to execute coded processing.

The disk drive 303 controls reading and writing of data from and to the disk 304 in accordance with the control of the CPU 301. The disk 304 stores the data written under the control of the disk drive 303. Examples of the disk 304 include a magnetic disk, an optical disk, and the like.

The communication I/F 305 is coupled to the network 210 (see FIG. 2) via a communication line, and is coupled to an external computer (for example, the client apparatuses 202 illustrated in FIG. 2) via the network 210. The communication I/F 305 functions as an interface between the network 210 and the inside of the apparatus and controls input and output of data from and to the external computer. As the communication I/F 305, for example, a modem, a LAN adapter, or the like may be used.

The portable-type recording medium I/F 306 controls reading and writing of data from and to the portable-type recording medium 307 in accordance with the control of the CPU 301. The portable-type recording medium 307 stores the data written under the control of the portable-type recording medium I/F 306. Examples of the portable-type recording medium 307 include a compact disc (CD)-ROM, a Digital Versatile Disk (DVD), a Universal Serial Bus (USB) memory, and the like.

In addition to the above-described components, for example, the communication management apparatus 201 may include an input device, a display, and the like.

(Hardware Configuration Example of Client Apparatus 202)

Next, a hardware configuration example of the client apparatus 202 will be described.

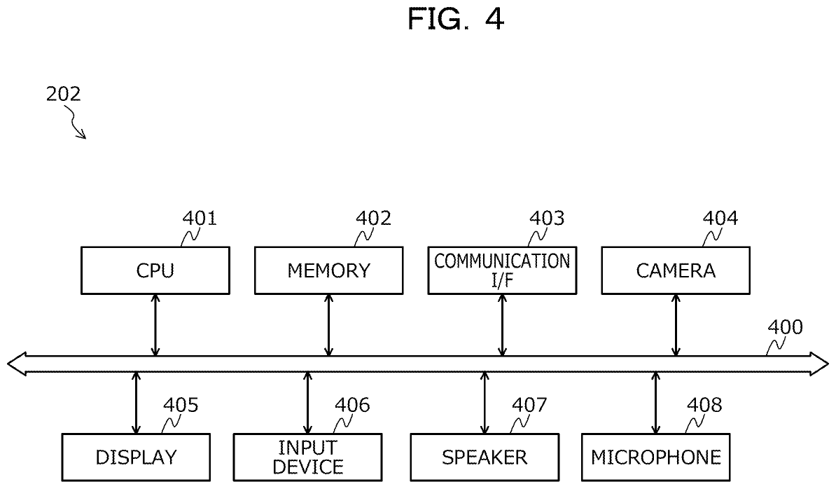

FIG. 4 is a diagram illustrating a hardware configuration example of the client apparatus 202. Referring to FIG. 4, the client apparatus 202 includes a CPU 401, a memory 402, a communication I/F 403, a camera 404, a display 405, an input device 406, a speaker 407, and a microphone 408. These components are coupled to one another through a bus 400.

The CPU 401 controls the entirety of the client apparatus 202. The CPU 401 may include a plurality of cores. The memory 402 is a storage unit having, for example, a ROM, a RAM, a flash ROM, and the like. For example, the flash ROM and the ROM store various programs, and the RAM is used as a work area for the CPU 401. The program stored in the memory 402 is loaded by the CPU 401, thereby causing the CPU 401 to execute coded processing.

The communication I/F 403 is coupled to the network 210 (see FIG. 2) via a communication line, and is coupled to an external computer (for example, the communication management apparatus 201) via the network 210. The communication I/F 403 functions as an interface between the network 210 and the inside of the apparatus and controls the input and output of data from and to external apparatuses.

The camera 404 is an imaging device that captures an image (still or moving image) and outputs image data. The camera 404 is disposed, for example, at a position where an image of the face of a user (participant) who is using the client apparatus 202 may be captured.

The display 405 is a display device that displays data such as a cursor, icons, and a toolbox, and also displays documents, images, functional information, and the like. The face of a robot, for example, may be output to the display 405. As the display 405, for example, a liquid crystal display, an organic electroluminescence (EL) display, or the like may be employed.

The input device 406 has keys for inputting characters, numbers, various instructions, and the like and is used for inputting data. The input device 406 may be a touch-panel input pad, a numeric keypad, or the like or may be a keyboard, a mouse, or the like. The speaker 407 converts an electric signal to audio and outputs the audio. The microphone 408 is an audio input device that receives audio and converts the audio to an electric signal.

In addition to the aforementioned components, the client apparatus 202 may have, for example, a hard disk drive (HDD), a solid-state drive (SSD), a near field communication I/F, a portable-type recording medium I/F, a portable-type recording medium and the like.

(Specific Example of Key Graph)

Next, with reference to FIG. 5, a specific example of a key graph to be used by the communication management apparatus 201 will be described. The key graph is one example of the first graph information 130 and the second graph information 140 illustrated in FIG. 1.

FIG. 5 is a diagram illustrating a specific example of the key graph. Referring to FIG. 5, a key graph 500 is graph information that includes elements 501 to 506 (black dots in FIG. 5) each representing a highly frequent word and an element 507 (white dot in FIG. 5) representing an insistence word and represents a relationship between elements having a co-occurrence relationship by a pillar.

In the following description, in a key graph, an element representing a highly frequent word is called “base”, an element representing an insistence word is called “roof”, and a broken line representing a relationship between elements having a co-occurrence relationship is called “pillar”, in some cases. For example, a pillar 514 represents a co-occurrence relationship between a word “rich” corresponding to an element 503 (base) and a word “design” corresponding to an element 507 (roof).

Time information is given to each of the elements 501 to 507, which indicates a point in time (time instance) when the term (word) corresponding to the element has been stated. When a word is stated a plurality of number of times, the time information indicates, for example, the latest time instance when the word has been stated. For example, time information “13:50:20” indicating the time instance when the word “rich” has been stated is given to the element 503 (base). Time information “13:41:00” indicating the time instance when the word “design” has been stated is given to the element 507 (roof).

(Stored Data in Evaluation Word DB 220)

Next, with reference to FIG. 6, stored data in the evaluation word DB 220 included in the communication management apparatus 201 will be described. The evaluation word DB 220 is, for example, implemented by a storage device, such as the memory 302, the disk 304, or the like of the communication management apparatus 201 illustrated in FIG. 3.

FIG. 6 is a diagram illustrating an example of stored data in the evaluation word DB 220. Referring to FIG. 6, the evaluation word DB 220 has fields of word/pillar, meeting room ID, and evaluation value and stores evaluation word information (for example, evaluation word information 600-1 and 600-2) as records by setting information in each field.

The word/pillar indicates a word included in a key graph or a pillar that couples words having a co-occurrence relationship. The word corresponds to a base or a roof included in a key graph. The meeting room ID is an identifier for uniquely identifying an online meeting. The evaluation value indicates an evaluation value corresponding to the word or pillar.

For example, the evaluation word information 600-1 indicates a word “study”, a meeting room ID “M1”, and an evaluation value “20”. The evaluation word information 600-2 indicates a pillar “study, economic growth rate”, a meeting room ID “M1”, and an evaluation value “20”. The pillar “study, economic growth rate” represents a pillar coupling study and economic growth rate.

(Functional Configuration Example of Communication Management Apparatus 201)

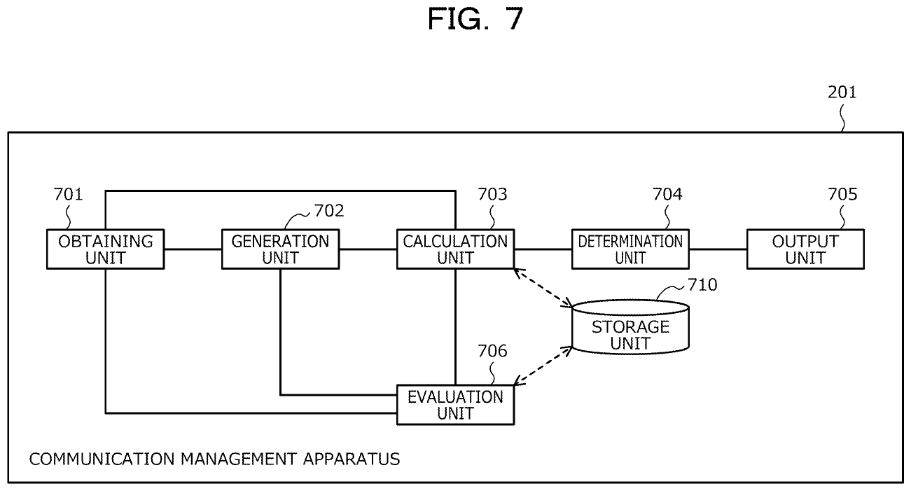

FIG. 7 is a diagram illustrating a functional configuration example of the communication management apparatus 201. Referring to FIG. 7, the communication management apparatus 201 includes an obtaining unit 701, a generation unit 702, a calculation unit 703, a determination unit 704, an output unit 705, an evaluation unit 706, and a storage unit 710. The obtaining unit 701 to the evaluation unit 706 are functions constituting a control unit, and these functions are each implemented, for example, by causing the CPU 301 to execute a program stored in a storage device such as the memory 302, the disk 304, the portable-type recording medium 307 or the like illustrated in FIG. 3 or by using the communication I/F 305. The processing results acquired by each of the functional units are stored, for example, in the storage device such as the memory 302, the disk 304, or the like. The storage unit 710 is implemented by, for example, a storage device such as the memory 302, the disk 304 or the like. For example, the storage unit 710 stores the evaluation word DB 220 illustrated in FIG. 6.

In the following description, an online meeting to be managed is called “online meeting M #” (where # is a natural number) in some cases. For that, a plurality of breakout rooms formed by grouping participants of the online meeting M # is called “breakout rooms R1 to Rn” in some cases. An arbitrary breakout room of the breakout rooms R1 to Rn is called “breakout room Ri” (where i=1, 2, . . . , n) in some cases. It is assumed that a manager exists for each breakout room Ri. For example, the manager may be any participant within the breakout room Ri or may be a person other than the participants.

The obtaining unit 701 obtains communication information on the breakout room Ri. The communication information is acquired by converting audio data acquired by recording data of a conversation of the breakout room Ri to text data. The audio data contains information (such as time instance information, for example) for identifying an utterance time.

For example, a meeting room ID and a room ID are given to audio data. The meeting room ID is an identifier for uniquely identifying an online meeting M #. The room ID is an identifier for uniquely identifying a breakout room Ri.

For example, the obtaining unit 701 obtains audio data acquired by recording data of a conversation in each breakout room Ri from the client apparatus 202 (see FIG. 2) of the manager or a participant of the breakout room Ri. The obtained audio data is converted to text data by the audio recognition engine 201-1 (see FIG. 2), and the obtaining unit 701 obtains communication information on each of the breakout rooms Ri. Information (such as time instance information, for example) for identifying an utterance time of each term (word), for example, is included in the communication information.

The audio recognition engine 201-1 may be implemented by, for example, another computer (such as the client apparatus 202 of the manager or a participant of each breakout room Ri, for example) different from the communication management apparatus 201. In this case, the obtaining unit 701 may obtain communication information on the breakout room Ri from the other computer. In a case where the online communication is text-based communication, the obtaining unit 701 may obtain text data representing details of a conversation in the breakout room Ri as the communication information from, for example, the client apparatus 202 of the manager or a participant of the breakout room Ri.

Meeting data on the online meeting M # and breakout room data on the breakout rooms R1 to Rn formed in the online meeting M # are managed in, for example, an electronic meeting application programming interface (API), not illustrated. The meeting data includes, for example, the meeting room ID of the online meeting M # and the room ID of the breakout room Ri within the online meeting M #. The breakout room data includes, for example, the room ID of the breakout room Ri and the participant IDs of the breakout room Ri. The participant ID is an identifier for uniquely identifying a participant (including the manager). As the participant ID, an Internet protocol (IP) address of the client apparatus 202, for example, may be used. The electronic meeting API is implemented by, for example, the communication management apparatus 201.

The generation unit 702 generates graph information on the breakout room Ri based on the obtained communication information. The graph information on the breakout room Ri is information indicating a relationship between elements of a plurality of elements included in the communication information on the breakout room Ri, and corresponds to, for example, the first graph information 130 and the second graph information 140 illustrated in FIG. 1.

In the following description, a “key graph” will be described as an example of the graph information on the breakout room Ri. For example, the key graph is a key graph 500 as illustrated in FIG. 5 and is graph information which includes an element (base) representing a highly frequent word and an element (roof) representing an insistence word and which represents a relationship between elements having a co-occurrence relationship by a pillar.

For example, the graph generation module 201-2 (see FIG. 2) calculates the appearance frequency of each of elements (words) included in the obtained communication information and the strength and number of associations between the elements, extracts a highly frequent word and an insistence word and extracts a co-occurrence relationship between the elements, and the generation unit 702 thus generates a key graph of the breakout room Ri.

In this operation, to each of the plurality of extracted elements, the generation unit 702 may give time information for identifying a point in time when the term (word) represented by the element has been stated, for example. As an algorithm for the key graph generation, an existing algorithm may be used. The point in time when the term (word) represented by each element is stated is identified based on, for example, time instance information for identifying an utterance time of the term (word) included in the communication information.

Thus, the generation unit 702 may generate a key graph (such as the key graph 500 illustrated in FIG. 5, for example) which indicates a relationship between elements of a plurality of elements included in the communication information on the breakout room Ri and in which each element of the plurality of elements is given time information for identifying a point in time when the word represented by the element is stated.

The generation unit 702 may generate a key graph of the breakout room Ri based on communication information indicating details of communications in a first time period of the breakout room Ri. The first time period is, for example, a most recent predetermined time period. The predetermined time period is arbitrarily settable and, for example, is set to a time period of about 5 to 10 minutes.

For example, the generation unit 702 extracts communication information within the most recent predetermined time period from the obtained communication information. The graph generation module 201-2 calculates the appearance frequency of each of elements included in the extracted communication information and the strength and number of associations between the elements, extracts a highly frequent word and an insistence word, and extracts a co-occurrence relationship between the elements, and the generation unit 702 thus generates a key graph of the breakout room Ri.

Thus, the generation unit 702 may generate a key graph based on the details of the most recent conversation of the breakout room Ri.

The graph generation module 201-2 may be implemented by, for example, another computer (such as the client apparatus 202 of the manager or a participant of each breakout room Ri, for example) different from the communication management apparatus 201. In this case, the obtaining unit 701 may obtain a key graph of the breakout room Ri from the other computer.

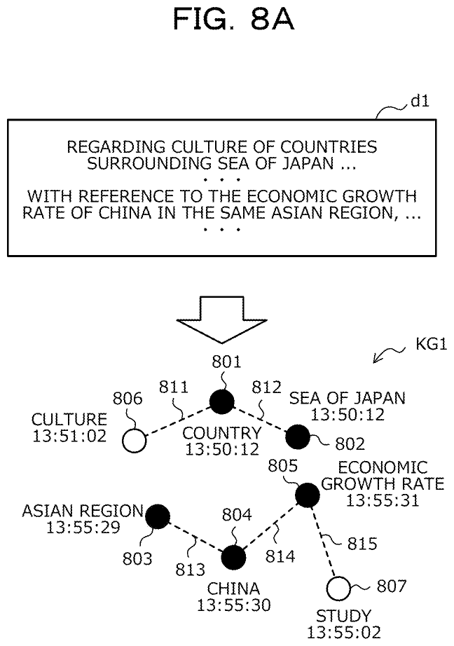

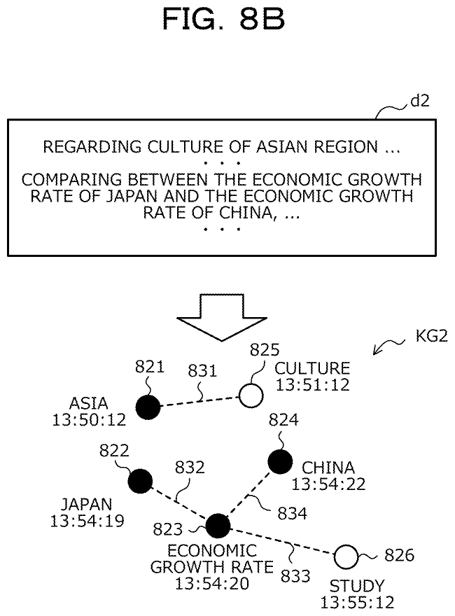

In the following description, the key graph of the breakout room Ri will be called “key graph KGi” in some cases. An example of generation of the key graph KGi will be described later with reference to FIGS. 8A and 8B.

The calculation unit 703 calculates a similarity between the key graph KGi of the breakout room Ri and a key graph KGj of a breakout room Rj based on a result of comparison between the key graph KGi and the key graph KGj (j≠i, j=1, 2, . . . , n).

The key graphs KGi and KGj are key graphs generated by the generation unit 702 or key graphs obtained by the obtaining unit 701. The key graph KGi corresponds to the “first graph information” described with reference to FIG. 1. The key graph KGj corresponds to the “second graph information” described with reference to FIG. 1.

For example, the calculation unit 703 extracts a matched part between the key graph KGi and the key graph KGj. In this operation, the calculation unit 703 may extract a matched part between the key graph KGi and the key graph KGj within a most recent predetermined time period.

For example, it is assumed that the key graphs KGi and KGj are key graphs based on communication information within a most recent predetermined time period on the breakout rooms Ri and Rj, respectively. In this case, the calculation unit 703 compares the key graph KGi and the key graph KGj and extracts a matched part between the key graph KGi and the key graph KGj.

It is assumed that the key graphs KGi and KGj are key graphs based on communication information from the beginning of conversations to the current time of the breakout rooms Ri and Rj, respectively. In this case, the calculation unit 703 extracts first partial graph information formed from elements having time information for identifying the points in time when the elements are stated within the most recent predetermined time period of the key graph KGi. The calculation unit 703 extracts second partial graph information formed from an element having time information for identifying the point in time when the element is stated within a most recent predetermined time period of the key graph KGj. The calculation unit 703 compares the extracted first partial graph information and second partial graph information and extracts a matched part between the first partial graph information and the second partial graph information.

The calculation unit 703 calculates a similarity between the key graph KGi and the key graph KGj based on evaluation values corresponding to elements included in the extracted part with reference to the storage unit 710. In association with each word of a plurality of words, the storage unit 710 stores an evaluation value for the word. In association with a combination of words included in a plurality of words, the storage unit 710 further stores an evaluation value for the combination of the words.

The evaluation value is an index to be used for determining a similarity between key graphs. For example, an evaluation value corresponding to a word is set such that the similarity between the key graph KGi and the key graph KGj increases as the evaluation value increases for the word which is included in the matched part between the key graph KGi and the key graph KGj. The evaluation value corresponding to a word corresponds to, for example, the evaluation value for a word within the evaluation word DB 220 illustrated in FIG. 6.

The evaluation value corresponding to a combination of words is set such that the similarity between the key graph KGi and the key graph KGj increases as the evaluation value increases for the combination of words which are included in the matched part between the key graph KGi and the key graph KGj. The evaluation value corresponding to a combination of words corresponds to, for example, the evaluation value for a pillar within the evaluation word DB 220.

The evaluation value corresponding to an element included in the extracted part is, for example, an evaluation value corresponding to an element (roof) representing an insistence word or an evaluation value corresponding to a pillar representing a relationship between elements included in the extracted part.

An evaluation value corresponding to an element included in the extracted part may not be stored in the storage unit 710 in some cases. In such cases, the calculation unit 703 may use, for example, an evaluation value (initial value) that is determined in advance as the evaluation value corresponding to the element included in the extracted part. The calculation unit 703 stores an evaluation value (initial value) in the storage unit 710 (such as the evaluation word DB 220, for example) as the evaluation value corresponding to an element included in the extracted part. The evaluation value (initial value) is set to “1”, for example.

For example, the calculation unit 703 may calculate a degree of matching of roof and a degree of matching of pillar as a similarity between the key graph KGi and the key graph KGj. The degree of matching of roof is an index value relating to a roof (element) that is matched between the key graph KGi and the key graph KGj. The degree of matching of pillar is an index value relating to a pillar (co-occurrence relationship between elements) that is matched between the key graph KGi and the key graph KGj.

The degree of matching of roof may be calculated by using, for example, the following expression (1), where a is a coefficient of matching of roof.

Degree of Matching of Roof=a×Evaluation Value for Roof (1)

In a case where a plurality of roofs exists in the extracted part, the calculation unit 703 calculates, as a degree of matching of roof, a total value of the degree of matching of roof of each of the plurality of roofs, for example.

The degree of matching of pillar may be calculated by using, for example, the following expression (2), where b is a coefficient of matching of pillar, and the coefficient b is set to a value higher than the coefficient a of the matching of roof included in the Expression (1) above, for example.

Degree of Matching of Pillar=b×Evaluation Value for Pillar (2)

In a case where a plurality of pillars exists in the extracted part, the calculation unit 703 calculates, as a degree of matching of pillar, a total value of the degree of matching of pillar of each of the plurality of pillars, for example. The calculation unit 703 may calculate, for example, a degree of matching of pillar only for pillars associated with roofs among a plurality of pillars included in the extracted part.

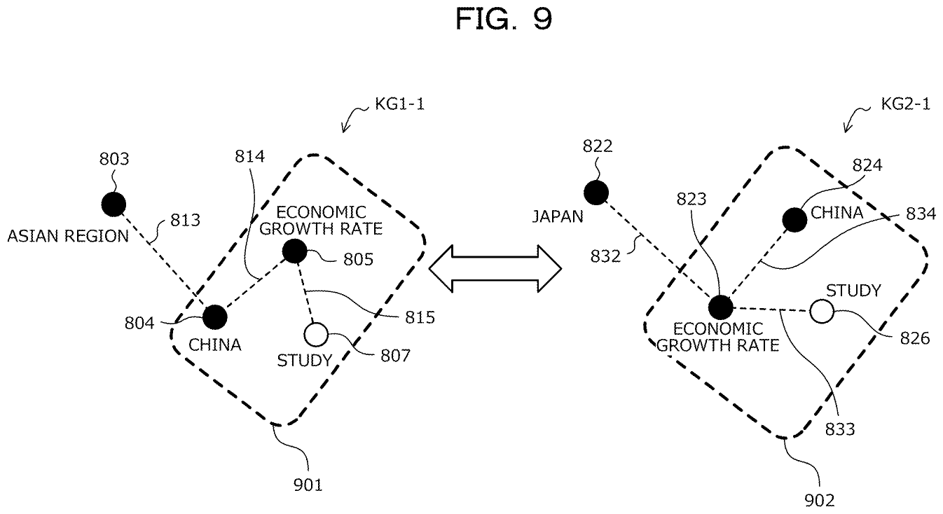

An example of calculation of a similarity between a key graph KG1 and a key graph KG2 will be described later with reference to FIG. 9.

The determination unit 704 determines whether the key graph KGi and the key graph KGj are similar or not based on the calculated similarity. For example, the determination unit 704 determines whether the calculated similarity is greater than or equal to a threshold value or not. When the similarity is greater than or equal to the threshold value, the determination unit 704 determines that the key graph KGi and the key graph KGj are similar. On the other hand, when the similarity is less than the threshold value, the determination unit 704 determines that the key graph KGi and the key graph KGj are not similar.

For example, the determination unit 704 determines whether the calculated degree of matching of roof is greater than or equal to a threshold value α or not. When the degree of matching of roof is less than the threshold value α, the determination unit 704 determines that the key graph KGi and the key graph KGj are not similar. On the other hand, when the degree of matching of roof is greater than or equal to the threshold value α, the determination unit 704 determines whether the calculated degree of matching of pillar is greater than or equal to a threshold value β or not.

When the degree of matching of pillar is less than the threshold value β, the determination unit 704 determines that the key graph KGi and the key graph KGj are not similar. On the other hand, when the degree of matching of pillar is greater than or equal to the threshold value β, the determination unit 704 determines that the key graph KGi and the key graph KGj are similar.

The threshold values α and β may be set arbitrarily. The threshold value α is set to, for example, a value whereby it may not be said that the key graph KGi and the key graph KGj are similar if the degree of matching of roof is not greater than or equal to the threshold value α. The threshold value β is set to, for example, a value whereby it may not be said that the key graph KGi and the key graph KGj are similar if the degree of matching of pillar is not greater than or equal to the threshold value β. The threshold values α and β may be the same value or may be different values.

The determination unit 704 may use the sum value of the calculated degree of matching of roof and degree of matching of pillar as the similarity. In this case, the calculation unit 703 determines whether the calculated similarity is greater than or equal to a threshold value γ or not. When the similarity is less than the threshold value γ, the determination unit 704 determines that the key graph KGi and the key graph KGj are not similar. On the other hand, when the similarity is greater than or equal to the threshold value γ, the determination unit 704 determines that the key graph KGi and the key graph KGj are similar.

The calculation unit 703 may calculate similarities between key graphs of breakout rooms for combinations of all breakout rooms included in the breakout rooms R1 to Rn, for example. The determination unit 704 may determine that the key graphs are similar for a combination of the higher X breakout rooms having higher calculated similarities among the combinations of all breakout rooms, for example.

When it is determined that the key graph KGi and the key graph KGj are similar, the output unit 705 outputs information that recommends to merge the breakout room Ri and the breakout room Rj. The output unit 705 outputs the information in a mode of, for example, storing it into a storage device such as the memory 302, the disk 304, or the like, transmitting it to another computer through the communication I/F 305, or presenting it on a display, not illustrated, of the communication management apparatus 201, or the like.

For example, the output unit 705 may transmit the merge recommendation information to the client apparatus 202 of the manager of each of the breakout rooms Ri and Rj. The merge recommendation information is information that recommends to merge breakout rooms having similar conversation details. For example, the merge recommendation information may include information for identifying a matched part between the key graph KGi and the key graph KGj.

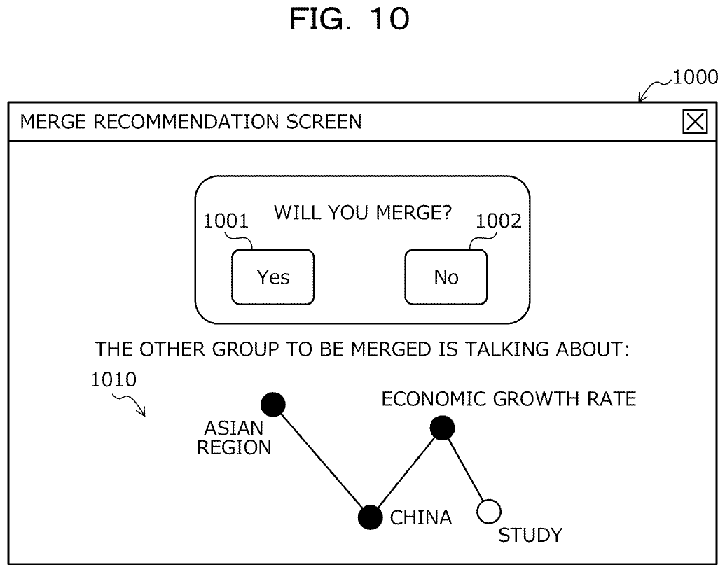

As a result, a merge recommendation screen 1000 as illustrated in FIG. 10, which will be described later, is displayed on the client apparatus 202 of the manager of each of the breakout rooms Ri and Rj.

The obtaining unit 701 obtains communication information on the breakout room after the merge that is obtained by merging the breakout room Ri and the breakout room Rj in accordance with the output information that recommends the merge. The communication information on the breakout room after the merge is acquired by converting, to text data, audio data acquired by recording data of the conversation during a time period from the time when the breakout room Ri and the breakout room Rj are merged to the time when the merge is cancelled, for example.

The generation unit 702 generates a key graph of the breakout room after the merge based on the obtained communication information. For example, the graph generation module 201-2 calculates the appearance frequency of each of elements included in the obtained communication information and the strength and number of associations between the elements, extracts a highly frequent word and an insistence word, and extracts a co-occurrence relationship between the elements, and the generation unit 702 thus generates a key graph of the breakout room after the merge.

The graph generation module 201-2 may be implemented by, for example, another computer (such as the client apparatus 202 of the manager or a participant of each breakout room Ri, for example) different from the communication management apparatus 201. In this case, the obtaining unit 701 may obtain a key graph of the breakout room after the merge from another computer.

The evaluation unit 706 evaluates validity of the merge between the breakout room Ri and the breakout room Rj based on the matched part between the key graph KGi and the key graph KGj and the key graph of the breakout room after the merge. For example, the evaluation unit 706 updates the evaluation value corresponding to an element included in the matched part based on the result of the comparison between the matched part and the key graph of the breakout room after the merge.

The evaluation unit 706 may update the evaluation value corresponding to the element included in the matched part based on the time period from a time when the breakout room Ri and the breakout room Rj are merged to a time when the merge is cancelled. The time period until the merge is cancelled is identified from the communication information on the breakout room after the merge, for example.

For example, the evaluation unit 706 selects a roof (element) included in a key graph of the breakout room after the merge. The evaluation unit 706 updates the evaluation value for a roof (element) by using the following expressions (3) and (4) in accordance with whether or not the selected roof (element) is included in the matched part between the key graph KGi and the key graph KGj, where X is a time period from a time when the breakout room Ri and the breakout room Rj are merged to a time when the merge is cancelled, c is a constant and, for example, is set to a value around 30, and Y is a variant that is “1” when a roof (element) included in the matched part exists in the key graph of the breakout room after the merge and is “0” when the roof (element) included in the matched part does not exist in the key graph of the breakout room after the merge.

f(X,Y)=(X−c)×Y (3)

Evaluation Value=Current Evaluation Value+f(X,Y) (4)

According to Expressions (3) and (4) above, the evaluation value increases when a roof (element) included in the matched part between the key graph KGi and the key graph KGj exists in the key graph of the breakout room after the merge and the conversation time period after the merge exceeds 30 seconds where “c=30”, for example.

The evaluation unit 706 stores the calculated evaluation value in the storage unit 710 in association with the selected roof. For example, with reference to the evaluation word DB 220, the evaluation unit 706 updates the evaluation value that corresponds to the selected roof and the meeting room ID of the online meeting M # with the calculated evaluation value.

Thus, when conversation is performed continuously for a certain time period (such as 30 seconds or longer, for example) in the breakout room after the merge and a roof included in the matched part between the key graphs KGi and KGj before the merge is included in the key graph after the merge, it is determined that the merge is valid, and the evaluation value for the roof may be increased.

For example, the evaluation unit 706 selects a pillar included in a key graph of the breakout room after the merge. The evaluation unit 706 updates the evaluation value for the pillar by using the following expressions (5) and (6) in accordance with whether or not the selected pillar is included in the matched part between the key graph KGi and the key graph KGj, where X is a time period from a time when the breakout room Ri and the breakout room Rj are merged to a time when the merge is cancelled, c is a constant and, for example, is set to a value around 30, and Z is a variant that is “1” when a pillar included in the matched part exists in the key graph of the breakout room after the merge and is “0” when the pillar included in the matched part does not exist therein.

f(X,Z)=(X−c)×Z (5)

Evaluation Value=Current Evaluation Value+f(X,Z) (6)

According to Expressions (5) and (6) above, the evaluation value increases when a pillar included in the matched part between the key graph KGi and the key graph KGj exists in the key graph of the breakout room after the merge and the conversation time period after the merge exceeds 30 seconds where “c=30”, for example.

The evaluation unit 706 stores the calculated evaluation value in the storage unit 710 in association with the selected pillar. For example, with reference to the evaluation word DB 220, the evaluation unit 706 updates the evaluation value that corresponds to the selected pillar and the meeting room ID of the online meeting M # with the calculated evaluation value.

Thus, when conversation is performed continuously for a certain time period (such as 30 seconds or longer, for example) in the breakout room after the merge and a pillar included in the matched part between the key graphs KGi and KGj before the merge is included in the key graph after the merge, it is determined that the merge is valid, and the evaluation value for the pillar may be increased.

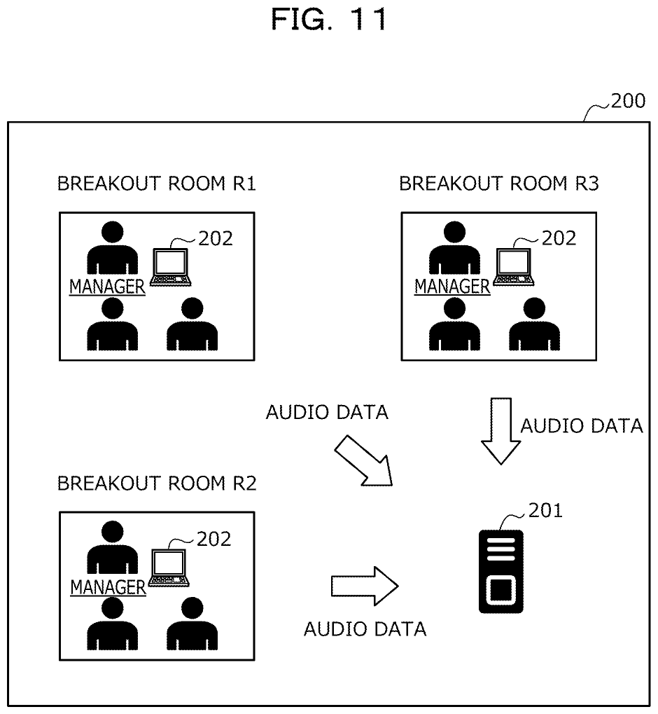

An evaluation example for the merge between the breakout room Ri and the breakout room Rj will be described later with reference to FIG. 11.

Although, in the description above, when the key graph KGi and the key graph KGj are similar, the communication management apparatus 201 outputs information that recommends to merge the breakout room Ri and the breakout room Rj, embodiments are not limited thereto. For example, when the key graph KGi and the key graph KGj are similar, the communication management apparatus 201 may automatically merge the breakout room Ri and the breakout room Rj.

The above-described functional units of the communication management apparatus 201 may be implemented by, for example, a plurality of computers (for example, the communication management apparatus 201 and the client apparatus 202) within the information processing system 200.

(Example of Generation of Key Graph KGi)

Next, an example of generation of the key graph KGi will be described with reference to FIGS. 8A and 8B. A case is assumed where an online meeting M1 is held under a subject “Problems involved in politics in the world”. The breakout rooms Ri and Rj are assumed as “breakout room R1” and “breakout room R2”, respectively. The breakout room R1 is a team for Japan. The breakout room R2 is a team for China.

FIGS. 8A and 8B are diagrams illustrating an example of generation of the key graph KGi. Referring to FIG. 8A, communication information d1 is text data converted from audio data acquired by recording data of a conversation of the breakout room R1. FIG. 8A illustrates an extracted part of the communication information d1.

The generation unit 702 generates a key graph KG1 by calculating the appearance frequency of each of elements (words) included in the communication information d1 and the strength and number of associations between the elements, extracting a highly frequent word and an insistence word, and extracting a co-occurrence relationship between the elements. In this operation, to each of the plurality of extracted elements, the generation unit 702 gives time information for identifying a point in time when the term (word) represented by the element has been stated.

The key graph KG1 is graph information that includes elements 801 to 805 (black dots in FIG. 8A) each representing a base (highly frequent word) and elements 806 and 807 (white dots in FIG. 8A) each representing a roof (insistence word), where elements having a co-occurrence relationship are coupled by the pillars 811 to 815. Time information is given to each of the elements 801 to 807, which indicates a point in time (time instance) when the term (word) corresponding to the element has been stated.

Referring to FIG. 8B, communication information d2 is text data converted from audio data acquired by recording data of a conversation of the breakout room R2. FIG. 8B illustrates an extracted part of the communication information d2.

The generation unit 702 generates a key graph KG2 by calculating the appearance frequency of each of elements (words) included in the communication information d2 and the strength and number of associations between the elements, extracting a highly frequent word and an insistence word, and extracting a co-occurrence relationship between the elements. In this operation, to each of the plurality of extracted elements, the generation unit 702 gives time information for identifying a point in time when the term (word) represented by the element has been stated.

The key graph KG2 is graph information that includes elements 821 to 824 (black dots in FIG. 8B) each representing a base (highly frequent word) and elements 825 and 826 (white dots in FIG. 8B) each representing a roof (insistence word), where elements having a co-occurrence relationship are coupled by pillars 831 to 834. Each of the elements 821 to 826 is given time information which indicates a point in time (time instance) when the term (word) corresponding to the element has been stated.

(Example of Calculation of Similarity Between Key Graph KG1 and Key Graph KG2)

An example of calculation of a similarity (degree of matching of roof, degree of matching of pillar) between a key graph KG1 and a key graph KG2 will be described next with reference to FIG. 9.

FIG. 9 is a diagram illustrating an example of extraction of a partial key graph. Referring to FIG. 9, a partial key graph KG1-1 is an example of first partial graph information formed from elements each having time information for identifying a point in time when the element is stated within a most recent predetermined time period (such as most recent 5 minutes, for example), which is extracted from the key graph KG1 by the calculation unit 703.

A partial key graph KG2-1 is an example of second partial graph information formed from elements each having time information for identifying a point in time when the element is stated within a most recent predetermined time period (such as most recent 5 minutes, for example), which is extracted from the key graph KG2 by the calculation unit 703.

In this case, the calculation unit 703 compares the partial key graph KG1-1 and the partial key graph KG2-1 and extracts a matched part 901 (or matched part 902) between the partial key graph KG1-1 and the partial key graph KG2-1. The calculation unit 703 calculates a similarity between the key graph KG1 and the key graph KG2 based on an evaluation value corresponding to an element included in the extracted matched part 901 (or matched part 902) with reference to the evaluation word DB 220.

For example, the calculation unit 703 calculates a degree of matching of roof by using Expression (1) above for a roof (element) included in the matched part 901 (or the matched part 902). It is assumed that an element 807 (or an element 826) representing the roof “study” is included in the matched part 901 (or the matched part 902). That is, the roof “study” is matched between the partial key graph KG1-1 and the partial key graph KG2-1.

Thus, the calculation unit 703 calculates a degree of matching of roof by using Expression (1) above for the roof “study”. First, the calculation unit 703 identifies an evaluation value “20” corresponding to the roof “study” and the meeting room ID “M1” with reference to the evaluation word DB 220. The calculation unit 703 calculates a degree of matching of roof by substituting the identified evaluation value “20” into Expression (1) above.

It is assumed that the coefficient a of the matching of roof is “a=1”. In this case, the degree of matching of roof is “20 (=20×1)”.

The calculation unit 703 calculates a degree of matching of pillar by using Expression (2) above for the pillar included in the matched part 901 (or the matched part 902). A pillar 815 (or a pillar 833) is included in the matched part 901 (or the matched part 902). That is, the pillar “study, economic growth rate” is matched between the partial key graph KG1-1 and the partial key graph KG2-1.

Thus, the calculation unit 703 calculates a degree of matching of pillar by using Expression (2) above for the pillar “study, economic growth rate”. First, the calculation unit 703 identifies an evaluation value “20” corresponding to the pillar “study, economic growth rate” and the meeting room ID “M1” with reference to the evaluation word DB 220. The calculation unit 703 calculates a degree of matching of pillar by substituting the identified evaluation value “20” into Expression (2) above.

It is assumed that the coefficient b of the matching of pillar is “b=2”. In this case, the degree of matching of pillar is “40(=20×2)”.

The determination unit 704 determines whether the calculated degree of matching of roof is greater than or equal to the threshold value α or not. It is assumed that the threshold value α is “α=20”. In this case, because the degree of matching of roof “20” is greater than or equal to the threshold value α, the determination unit 704 determines whether the calculated degree of matching of pillar is greater than or equal to the threshold value β or not. It is assumed that the threshold value β is “β=30”.

In this case, because the degree of matching of pillar “40” is greater than or equal to the threshold value β, the determination unit 704 determines that the key graph KG1 and the key graph KG2 are similar. The calculation unit 703 may calculate the degree of matching of pillar when the degree of matching of roof is greater than or equal to the threshold value α.

When it is determined that, for example, the key graph KG1 and the key graph KG2 are similar, the output unit 705 transmits merge recommendation information to the client apparatus 202 of the manager of each of the breakout rooms R1 and R2. As a result, the merge recommendation screen 1000 as illustrated in FIG. 10 is displayed on the client apparatus 202 of the managers of the breakout rooms R1 and R2.

(Screen Example of Merge Recommendation Screen)

Next, with reference to FIG. 10, a screen example of the merge recommendation screen to be displayed on the client apparatus 202 of the manager of the breakout room Ri will be described.

FIG. 10 is a diagram illustrating a screen example of the merge recommendation screen. Referring to FIG. 10, the merge recommendation screen 1000 is an example of an operation screen for recommending the manager of the breakout room R2 to merge with another breakout room (breakout room R1).

A key graph 1010 is displayed on the merge recommendation screen 1000. The key graph 1010 is a key graph generated immediately previously for the other breakout room (breakout room R1) to be merged. For example, the key graph 1010 is graph information based on communication information for most recent 5 minutes.

From the merge recommendation screen 1000, the manager of the breakout room R2 recognizes that the merge with the other breakout room (breakout room R1) is being recommended. With reference to the key graph 1010, the manager of the breakout room R2 may determine that what kind of details the other breakout room recommended to be merged is talking.

The key graph 1010 includes the matched part 901 between the partial key graph KG1-1 and the partial key graph KG2-1 illustrated in FIG. 9. Thus, the manager of the breakout room R2 may determine that the other breakout room to be merged is talking about similar details to details of the conversation of the breakout room R2.

When a Yes button 1001 is selected through an operation input by a user (manager of the breakout room R2) using, for example, the input device 406 illustrated in FIG. 4 on the merge recommendation screen 1000, the breakout room R1 and the breakout room R2 may be merged.

For example, when the Yes button 1001 is selected, a merge request is transmitted from the client apparatus 202 to the electronic meeting API (not illustrated) through the communication management apparatus 201. When, for example, the electronic meeting API (not illustrated) receives the merge request from the client apparatuses 202 of the managers of both of the breakout rooms R1 and R2, the electronic meeting API merges the breakout room R1 and the breakout room R2. As a result, people in the breakout rooms R1 and R2 are allowed to talk together.

When a No button 1002 is selected through an operation input by a user (manager of the breakout room R2) using, for example, the input device 406 on the merge recommendation screen 1000, the merge between the breakout room R1 and the breakout room R2 may be rejected. In this case, the merge between the breakout room R1 and the breakout room R2 is not performed.

(Example of Operations of Information Processing System 200)

Next, an example of operations of the information processing system 200 will be described with reference to FIGS. 11 to 14. It is assumed that the online meeting M # is “online meeting M1”, and the breakout rooms R1 to Rn are “breakout rooms R1 to R3” (where n=3).

FIGS. 11 to 14 are diagrams illustrating examples of operations of the information processing system 200. Referring to FIG. 11, the communication management apparatus 201 obtains audio data acquired by recording data of a conversation in each of the breakout rooms R1 to R3 from the client apparatus 202 of the manager of each of the breakout rooms R1 to R3.

The communication management apparatus 201 converts the audio data of each of the breakout rooms R1 to R3 to text data and thus obtains communication information on each of the breakout rooms R1 to R3. The communication management apparatus 201 generates a key graph of each of the breakout rooms R1 to R3 based on the communication information on each of the breakout rooms R1 to R3.

A case is assumed that the key graph of the breakout room R1 and the key graph of the breakout room R2 are similar.

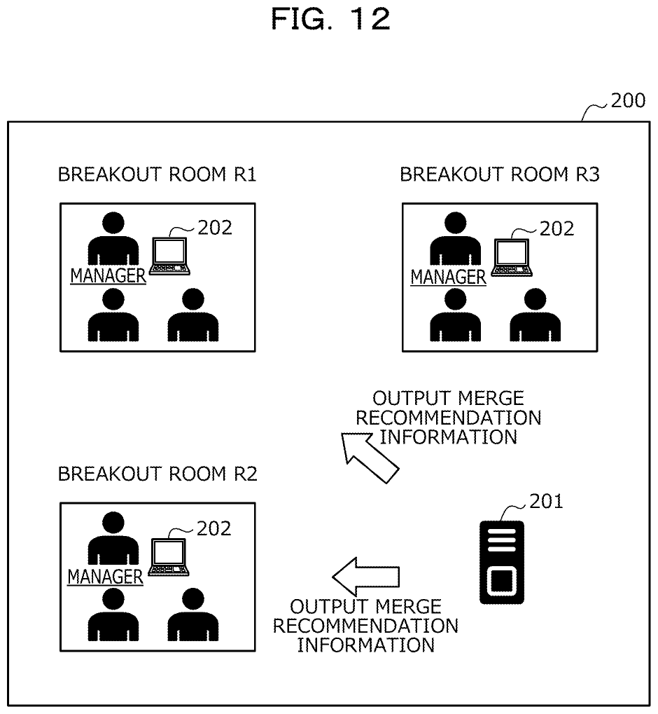

Referring to FIG. 12, the communication management apparatus 201 outputs merge recommendation information to the client apparatus 202 of the manager of each of the breakout rooms R1 and R2. As a result, the merge recommendation screen is displayed on the client apparatus 202 of the manager of each of the breakout rooms R1 and R2.

A case is assumed that the managers of both of the breakout rooms R1 and R2 have permitted the merge.

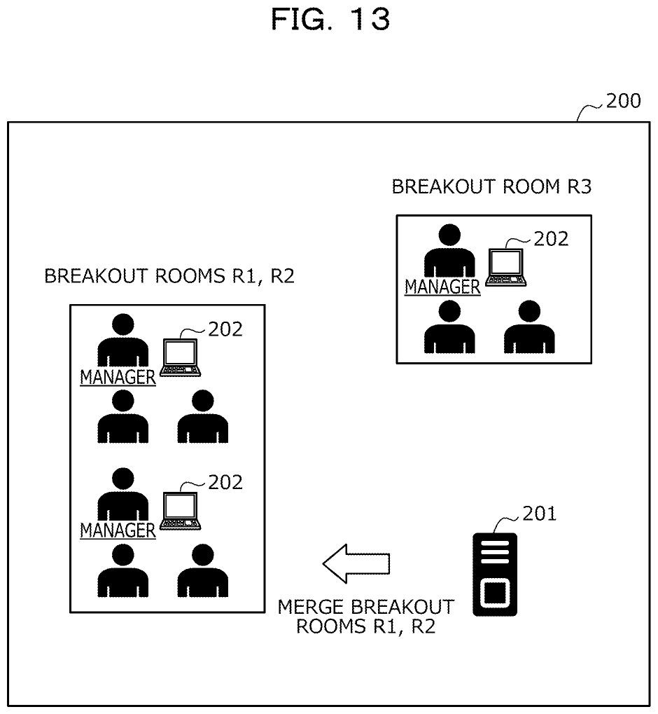

Referring to FIG. 13, the communication management apparatus 201 merges the breakout room R1 and the breakout room R2. As a result, participants in the breakout rooms R1 and R2 are allowed to talk together. When the breakout rooms R1 and R2 are in a merged state, a key graph of the breakout room after the merge is generated.

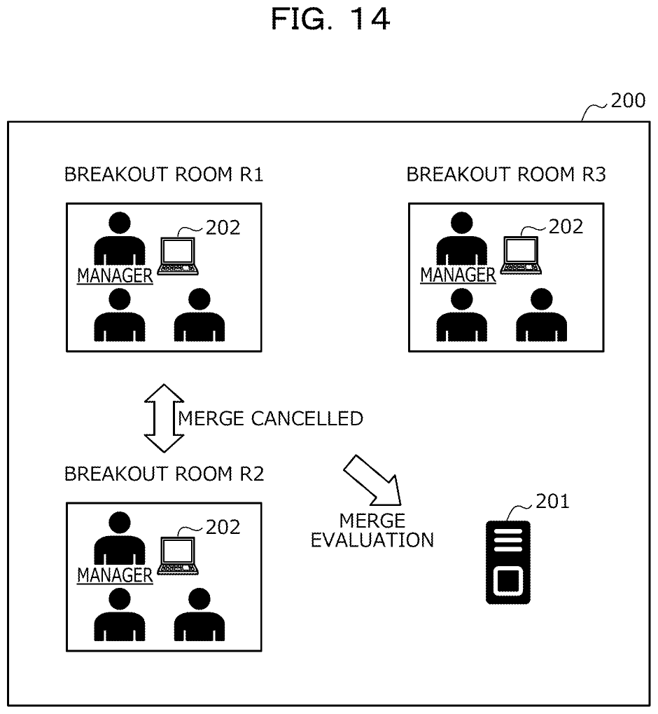

Referring to FIG. 14, when the merge between the breakout room R1 and the breakout room R2 is cancelled, the communication management apparatus 201 evaluates the validity of the merge between the breakout room R1 and the breakout room R2.

(Evaluation Example for Merge of Breakout Rooms Ri and Rj)

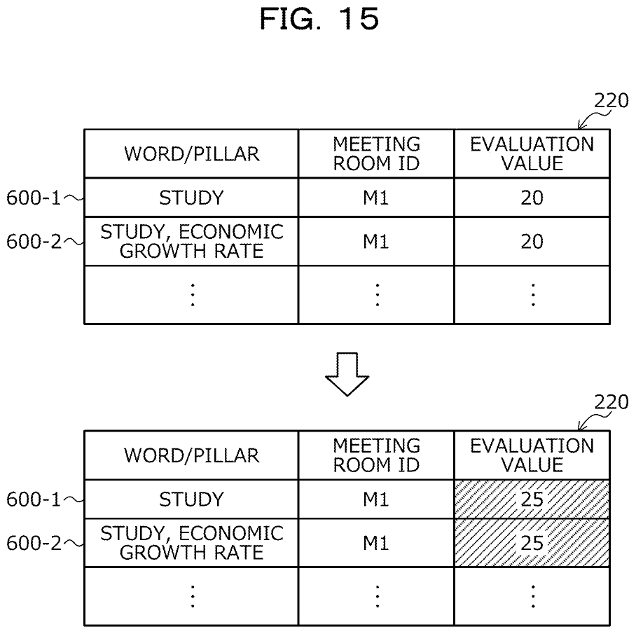

With reference to FIG. 15, an evaluation example for the merge between the breakout room Ri and the breakout room Rj will be described next.

FIG. 15 is a diagram illustrating an example of update of stored data in the evaluation word DB 220. A case is assumed that the breakout room R1 and the breakout room R2 are merged in the online meeting M1. The breakout room after the merge in which the breakout room R1 and the breakout room R2 are merged is called “breakout room R′ after the merge”, and a key graph of the breakout room R′ after the merge is called “key graph KG′”.

In this case, the evaluation unit 706 evaluates validity of the merge between the breakout room R1 and the breakout room R2 based on, for example, the matched part 901 (or the matched part 902) illustrated in FIG. 9 and the key graph KG′ of the breakout room R′ after the merge. It is assumed that a time period X from a time when the breakout room R1 and the breakout room R2 are merged to a time when the merge is cancelled is “X=35 seconds”.

It is assumed that the element 807 representing the roof “study” included in the matched part 901 exists in the key graph KG′ of the breakout room R′ after the merge (Y=1). In this case, the evaluation unit 706 identifies the current evaluation value “20” corresponding to the roof “study” and the meeting room ID “M1” with reference to the evaluation word DB 220.

The evaluation unit 706 calculates a new evaluation value by substituting the identified current evaluation value “20”, the time X “X=35”, and the variable Y “Y=1” into Expressions (3) and (4) above. It is assumed that the constant c is “c=30”.

In this case, the new evaluation value is “25(=20+(35−30)×1)”. With reference to the evaluation word DB 220, the evaluation unit 706 updates the evaluation value “20” for the evaluation word information 600-1 corresponding to the roof “study” and the meeting room ID “1” of the online meeting M1 with the calculated evaluation value “25”.

It is assumed that the pillar 815 included in the matched part 901 exists in the key graph KG′ of the breakout room R′ after the merge (Z=1). In this case, the evaluation unit 706 identifies the current evaluation value “20” corresponding to the pillar “study, economic growth rate” and the meeting room ID “M1” with reference to the evaluation word DB 220.

The evaluation unit 706 calculates a new evaluation value by substituting the identified current evaluation value “20”, the time X “X=35”, and the variable Z “Z=1” into Expressions (5) and (6) above. It is assumed that the constant c is “c=30”.

In this case, the new evaluation value is “25(=20+(35−30)×1)”. With reference to the evaluation word DB 220, the evaluation unit 706 updates the evaluation value “20” for the evaluation word information 600-2 corresponding to the pillar “study, economic growth rate” and the meeting room ID “1” of the online meeting M1 with the calculated evaluation value “25”.

In this way, the communication management apparatus 201 may manage the evaluation values for a roof and a pillar in association with a meeting room ID. Thus, when the online meeting M # for the same purpose is performed, the similarity between the key graphs KGi and KGj may be acquired by using the updated evaluation values so that the precision of the merge recommendation may be enhanced. The risk that the evaluation values are applied for an online meeting for a different purpose may be precluded.

(Various Processing by Communication Management Apparatus 201)

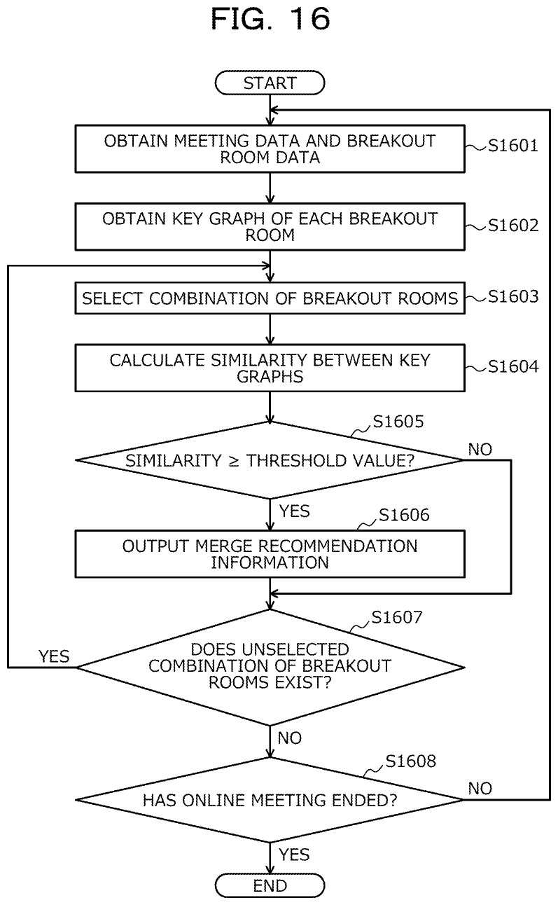

Next, various processing by the communication management apparatus 201 will be described. First, with reference to FIG. 16, merge recommendation processing by the communication management apparatus 201 will be described.

FIG. 16 is a flowchart illustrating an example of merge recommendation processing by the communication management apparatus 201. Referring to the flowchart in FIG. 16, the communication management apparatus 201 first obtains meeting data on an online meeting M # that is being held and breakout room data thereof (step S1601). The meeting data and the breakout room data are obtained from, for example, the electronic meeting API (not illustrated).

With reference to the obtained meeting data and the breakout room data, the communication management apparatus 201 obtains a key graph KGi of each breakout room Ri of the breakout rooms R1 to Rn (step S1602). The key graph KGi may be acquired by generating the key graph KGi based on the communication information on the breakout room Ri or may be obtained by receiving the key graph KGi from another computer.

Next, the communication management apparatus 201 selects an unselected combination of breakout rooms, which is not yet selected, from the breakout rooms R1 to Rn (step S1603). The selected combination of the breakout rooms is called “breakout rooms Ri and Rj”.

The communication management apparatus 201 calculates a similarity between the key graph KGi of the breakout room Ri and a key graph KGj of a breakout room Rj based on a result of comparison between the key graph KGi and the key graph KGj (step S1604). Next, the communication management apparatus 201 determines whether or not the calculated similarity is greater than or equal to a threshold value (step S1605).

When the similarity is less than the threshold value (No in step S1605), the communication management apparatus 201 moves to step S1607. On the other hand, when the similarity is greater than or equal to the threshold value (Yes in step S1605), the communication management apparatus 201 outputs merge recommendation information to the client apparatus 202 of the manager of each of the breakout rooms Ri and Rj with reference to the obtained meeting data and breakout room data (step S1606).

The communication management apparatus 201 determines whether or not any unselected combination of breakout rooms, which is not yet selected, from the breakout rooms R1 to Rn exists (step S1607). When some unselected combination of breakout rooms exists (Yes in step S1607), the communication management apparatus 201 returns to step S1603.

On the other hand, when no unselected combination of breakout rooms exists (No in step S1607), the communication management apparatus 201 determines whether or not the online meeting M # has ended (step S1608). When the online meeting M # has not ended (No in step S1608), the communication management apparatus 201 returns to step S1601.

On the other hand, when the online meeting M # has ended (Yes in step S1608), the communication management apparatus 201 ends the series of processing steps according to the flowchart.

Thus, the communication management apparatus 201 may recommend to merge the breakout rooms Ri and Rj having similar conversation details by comparing in context-based manner the conversation details of the breakout rooms Ri and Rj.

When some breakout room after the merge exists in step S1603, the communication management apparatus 201 may exclude the breakout room after the merge from the selection targets. In steps S1603 to S1607, the communication management apparatus 201 may calculate similarities of key graphs for combinations of all breakout rooms included in the breakout rooms R1 to Rn and output merge recommendation information for the higher X breakout rooms having the higher calculated similarities.

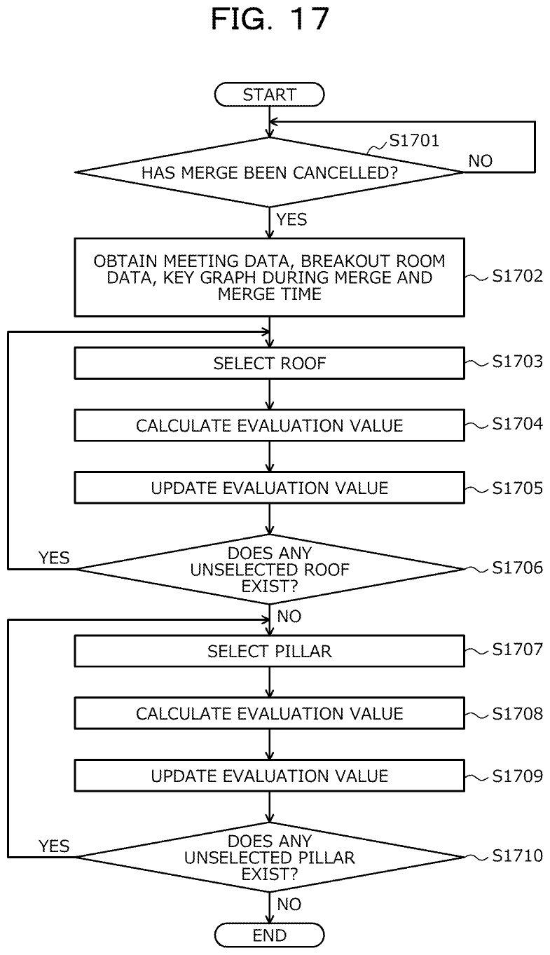

Next, with reference to FIG. 17, merge evaluation processing by the communication management apparatus 201 will be described.

FIG. 17 is a flowchart illustrating an example of processing for merge evaluation in the communication management apparatus 201. Referring to the flowchart in FIG. 17, the communication management apparatus 201 first determines whether or not the merge between the breakout rooms Ri and Rj has been cancelled (step S1701).

The communication management apparatus 201 waits for cancellation of the merge between the breakout rooms Ri and Rj (No in step S1701). Whether the merge has been cancelled or not may be determined, for example, from a notification from the electronic meeting API or by inquiring of the electronic meeting API.

When the merge between the breakout rooms Ri and Rj is cancelled (Yes in step S1701), the communication management apparatus 201 obtains meeting data, breakout room data, a key graph during the merge, and the merge time (step S1702).

The meeting data is meeting data on the online meeting M # including the merged breakout rooms Ri and Rj. The breakout room data are breakout room data on the merged breakout rooms Ri and Rj. The key graph during the merge is a key graph of the breakout room after the merge. The merge time is a time period from a time when the breakout rooms Ri and Rj are merged to a time when the merge is cancelled.

Next, the communication management apparatus 201 selects an unselected roof (element), which is not yet selected, from the key graph during the merge (step S1703). The communication management apparatus 201 calculates an evaluation value for the roof (element) by using the expressions (3) and (4) above in accordance with whether the selected roof (element) is included in the matched part between the key graph KGi and the key graph KGj before the merge or not (step S1704).

The information for identifying a matched part between the key graph KGi and the key graph KGj before the merge is, for example, stored in a storage device such as the memory 302, the disk 304, or the like in association with the merged breakout room Ri and Rj.

Next, with reference to the evaluation word DB 220, the communication management apparatus 201 updates the evaluation value that corresponds to the selected roof and the meeting room ID of the online meeting M # with the calculated evaluation value (step S1705). The communication management apparatus 201 determines whether or not any unselected roof that is not yet selected from the key graph during the merge exists (step S1706).

When some unselected roof exists (Yes in step S1706), the communication management apparatus 201 returns to step S1703. On the other hand, when no unselected roof exists (No in step S1706), the communication management apparatus 201 selects an unselected pillar, which is not yet selected, from the key graph during the merge (step S1707).

The communication management apparatus 201 calculates an evaluation value of the pillar by using the expressions (5) and (6) above in accordance with whether the selected pillar is included in the matched part between the key graph KGi and the key graph KGj before the merge or not (step S1708).

Next, with reference to the evaluation word DB 220, the communication management apparatus 201 updates the evaluation value that corresponds to the selected pillar and the meeting room ID of the online meeting M # with the calculated evaluation value (step S1709). The communication management apparatus 201 determines whether or not any unselected pillar that is not yet selected from the key graph during the merge exists (step S1710).

When some unselected pillar exists (Yes in step S1710), the communication management apparatus 201 returns to step S1707. On the other hand, when no unselected pillar exists (No in step S1710), the communication management apparatus 201 ends the series of processing steps according to this flowchart.

Thus, the communication management apparatus 201 may determine the validity of the merge of the breakout rooms Ri and Rj and may update the evaluation value to be used for determining similarity between the key graphs.

As described above, with the communication management apparatus 201 according to this embodiment, the key graph KGi of the breakout room Ri and the key graph KGj of the breakout room Rj may be obtained, and, when it is determined that the key graph KGi and the key graph KGj are similar based on a result of a comparison between the key graph KGi and the key graph KGj, information that recommends to merge the breakout room Ri and the breakout room Rj may be output. Each of the key graphs KGi and KGj is graph information that has a highly frequent word and an insistence word included in communication information on each of the breakout rooms Ri and Rj as elements and represents a relationship between elements having a co-occurrence relationship by a pillar.

Thus, the communication management apparatus 201 may recommend to merge the breakout rooms Ri and Rj having similar conversation details by comparing in context-based manner the conversation details of the breakout rooms Ri and Rj.

It may be considered that stated details in two groups (breakout rooms) are compared, and when the two groups are determined as the groups in which the same subject is being talked if an identical stated detail appears, the two groups are automatically merged. However, only by simply comparing stated details, a “part not related to the subject of the discussion” and an “important part for the subject of the discussion” may be evaluated equally in some cases. In this case, when there is a matched stated detail in a part not related to the subject of the discussion, the two groups may be merged although the subjects of the discussion in the two groups are different. For example, when a participant in each of two groups states, for example, “I'll go to bathroom” at the same time as each other, an improper merge of the groups may occur although different subjects are discussed in the two groups.

Against this, by utilizing the key graphs KGi and KGj based on the communication information on each of the breakout rooms Ri and Rj, the communication management apparatus 201 may compare details of the conversations in context-based manner between the breakout rooms Ri and Rj and thus recommend to merge the breakout rooms Ri and Rj having similar details of the conversations.

With the communication management apparatus 201, a similarity between the key graph KGi and the key graph KGj may be calculated based on a result of a comparison between the key graph KGi and the key graph KGj, and, when the calculated similarity is greater than or equal to a threshold value, information that recommends to merge the breakout room Ri and the breakout room Rj may be output.

Thus, the communication management apparatus 201 may suppress the merge recommendation from occurring many times for breakout rooms having a low degree of matching between their key graphs.

With the communication management apparatus 201, a matched part between the key graph KGi and the key graph KGj may be extracted, and a similarity between the key graph KGi and the key graph KGj may be calculated based on an evaluation value corresponding to an element included in the matched part with reference to the storage unit 710 (such as the evaluation word DB 220, for example). The evaluation value corresponding to an element included in the matched part is, for example, at least one of an evaluation value corresponding to a roof (element) included in the matched part and an evaluation value corresponding to a pillar included in the matched part.

Thus, the communication management apparatus 201 may determine the similarity between the key graphs by using the evaluation value that is set for each of a roof and a pillar.

With the communication management apparatus 201, a key graph of the breakout room after the merge, which is generated by merging the breakout room Ri and the breakout room Rj in accordance with the output recommendation information, may be obtained. The communication management apparatus 201 may evaluate validity of the merge between the breakout room Ri and the breakout room Rj based on the matched part between the key graph KGi and the key graph KGj before the merge and the key graph of the breakout room after the merge.

Thus, the communication management apparatus 201 may evaluate the validity of the merge of the breakout rooms Ri and Rj in accordance with whether a roof or pillar included in the matched part between the key graphs KGi and KGj before the merge, on which the merge recommendation is based, appears in the key graph of the breakout room after the merge.

With the communication management apparatus 201, the evaluation value corresponding to an element included in the key graph of the breakout room after the merge may be updated based on a result of a comparison between the matched part between the key graph KGi and the key graph KGj before the merge and the key graph of the breakout room after the merge. The evaluation value corresponding to an element included in the key graph of the breakout room after the merge is, for example, at least one of an evaluation value corresponding to a roof (element) included in the key graph of the breakout room after the merge and an evaluation value corresponding to a pillar included in the key graph of the breakout room after the merge. With the communication management apparatus 201, the evaluation value corresponding to the element included in the key graph of the breakout room after the merge may be updated based on the time period from a time when the breakout room Ri and the breakout room Rj are merged to a time when the merge is cancelled.

Thus, the communication management apparatus 201 may determine the validity of the merge of the breakout rooms Ri and Rj and may update the evaluation value to be used for determining similarity between the key graphs.

With the communication management apparatus 201, the key graph KGi based on communication information within a most recent predetermined time period of the breakout room Ri and the key graph KGj based on communication information within the most recent predetermined time period of the breakout room Rj may be obtained.

Thus, the communication management apparatus 201 may recommend to merge the breakout rooms Ri and Rj having similar conversation details in the most recent time period.

With the communication management apparatus 201, the key graph KGi may be obtained by generating the key graph KGi which indicates a relationship between elements of a plurality of elements (for example, a co-occurrence relationship between elements) included in the communication information on the breakout room Ri and in which each element of the plurality of elements is given time information for identifying a point in time when the word represented by the element is stated. With the communication management apparatus 201, the key graph KGj may be acquired by generating the key graph KGj which indicates a relationship between elements of a plurality of elements included in the communication information on the breakout room Rj and in which each element of the plurality of elements is given time information for identifying a point in time when the word represented by the element is stated. With the communication management apparatus 201, first partial graph information (partial key graph) formed from an element having time information for identifying a point in time when the element is stated within a most recent predetermined time period may be extracted from the key graph KGi, second partial graph information (partial key graph) formed from an element having time information for identifying a point in time when the element is stated within the most recent predetermined time period may be extracted from the key graph KGj, and, based on a result of a comparison between the extracted first partial graph information and the extracted second partial graph information, a similarity between the key graph KGi and the key graph KGj may be calculated.

Thus, the communication management apparatus 201 may calculate a similarity between the key graphs by using information for a time period around the most recent 5 to 10 minutes of each of the key graphs KGi and KGj. Thus, merge of the breakout rooms Ri and Rj having similar conversation details in the most recent time period may be recommended. For example, merge recommendations generated because details of the past conversations are similar although details of the most recent conversations are different may be suppressed.

In this way, with the communication management apparatus 201, breakout rooms in which similar subjects are being talked may be merged even when groups of participants have started conversations in the online meeting M #. Thus, the people belonging to the different groups but talking about similar subjects are allowed to talk together so that, for example, they may advantageously dig deeper into the subject, augmenting the scene or achieving more meaningful discussion.

The communication management method described in this embodiment may be implemented by executing a program prepared in advance on a computer such as a personal computer, a workstation, or the like. The communication management program is recorded on a computer-readable recording medium such as a hard disk, a flexible disk, a CD-ROM, a DVD, a USB memory, or the like and is executed by being read by the computer from the recording medium. The communication management program may also be distributed via a network such as the Internet or the like.

The information processing apparatus 101 (communication management apparatus 201) described in the embodiment may also be implemented by an IC for a specific application, such as a standard cell, a structured application-specific integrated circuit (ASIC) or the like, or by a programmable logic device (PLD), such as a field-programmable gate array (FPGA) or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be under stood that the various changes, substitutions, and alterations could be made hereto without departing from the spirit and scope of the invention.

What is claimed is:

1. A non-transitory computer-readable recording medium storing a program that causes a computer to execute a process, the process comprising:
obtaining first graph information indicating a relationship between elements of a plurality of elements included in communication information on a first group;
obtaining second graph information indicating a relationship between elements of a plurality of elements included in communication information on a second group;
comparing the first graph information and the second graph information; and
outputting information that recommends to merge the first group and the second group when it is determined that the first graph information and the second graph information are similar based on a result of the comparison.

2. The non-transitory computer-readable recording medium according to claim 1, wherein
the first graph information and the second graph information are graphs each of which includes an element representing a highly frequent word and an element representing an insistence word and represents a relationship between elements having a co-occurrence relationship by coupling; and
the process further comprises:
extracting a matched part between the first graph information and the second graph information; and
calculating a similarity between the first graph information and the second graph information based on an evaluation value corresponding to an element included in the matched part with reference to evaluation information that stores an evaluation value for each word of a plurality of words and an evaluation value for a combination of words included in the plurality of words.

3. The non-transitory computer-readable recording medium according to claim 2, wherein
the evaluation value corresponding to an element included in the matched part is at least one of an evaluation value corresponding to an element representing an insistence word included in the matched part and an evaluation value corresponding to a pillar representing a relationship between elements included in the matched part and having a co-occurrence relationship.

4. The non-transitory computer-readable recording medium according to claim 2, the process further comprising:
obtaining third graph information representing a relationship between elements of a plurality of elements included in communication information on a third group obtained by merging the first group and the second group in accordance with the information that recommends to merge; and
evaluating validity of the merge based on the matched part and the third graph information.

5. The non-transitory computer-readable recording medium according to claim 4, the process further comprising:
updating an evaluation value corresponding to an element included in the third graph information based on a result of a comparison between the matched part and the third graph information.

6. The non-transitory computer-readable recording medium according to claim 5, the process further comprising:
updating the evaluation value corresponding to the element included in the third graph information based on a time period from a time when the first group and the second group are merged to a time when the merge is cancelled.

7. The non-transitory computer-readable recording medium according to claim 5, wherein
the evaluation value corresponding to an element included in the third graph information is at least one of an evaluation value corresponding to an element representing an insistence word included in the third graph information and an evaluation value corresponding to a pillar representing a relationship between elements included in the third graph information and having a co-occurrence relationship.

8. The non-transitory computer-readable recording medium according to claim 1, wherein
the communication information on the first group indicates details of communication in the first group during a first time period; and
the communication information on the second group indicates details of communication in the second group during the first time period.

9. The non-transitory computer-readable recording medium according to claim 1, wherein
each of the plurality of elements included in the communication information on the first group is given, in the first graph information, with first time information for identifying a point in time when a word representing a relevant element is stated,
each of the plurality of elements included in the communication information on the second group is given, in the second graph information, with second time information for identifying a point in time when a word representing a relevant element is stated,
the process further comprises:
extracting first partial graph information formed from elements having the first time information within a most recent predetermined time period from the first graph information;
extracting second partial graph information formed from elements having the second time information within the most recent predetermined time period from the second graph information; and
based on a result of a comparison between the extracted first partial graph information and the extracted second partial graph information, calculating a similarity between the first graph information and the second graph information.

10. A communication management method, comprising:
obtaining, by a computer, first graph information indicating a relationship between elements of a plurality of elements included in communication information on a first group;
obtaining second graph information indicating a relationship between elements of a plurality of elements included in communication information on a second group;
comparing the first graph information and the second graph information; and
outputting information that recommends to merge the first group and the second group when it is determined that the first graph information and the second graph information are similar based on a result of the comparison.

11. An information processing apparatus, comprising:
a memory; and
a processor coupled to the memory and the processor configured to:
obtain first graph information indicating a relationship between elements of a plurality of elements included in communication information on a first group;
obtain second graph information indicating a relationship between elements of a plurality of elements included in communication information on a second group;
compare the first graph information and the second graph information; and
output information that recommends to merge the first group and the second group when it is determined that the first graph information and the second graph information are similar based on a result of the comparison.
